(19) United States
(12) Patent Application Publication
(10) Pub. No.: US 2016/0110290 A1
(43) Pub. Date: Apr. 21, 2016

(54) DATA CACHE AND METHOD FOR DATA CACHING

(71) Applicant: EMC Corporation, Hopkinton, MA (US)

(72) Inventors: Ted Huaqi Chen, Shanghai (CN); Tao Zheng, Shanghai (CN)

(21) Appl. No.: 14/883,138

(22) Filed: Oct. 14, 2015

(30) Foreign Application Priority Data
Oct. 20, 2014 (CN) 201410562465.6

(51) Int. Cl. G06F 12/08; G06F 12/02; G06F 13/40; G06F 13/38; G06F 13/42

(52) U.S. Cl. CPC G06F 12/0875; G06F 12/0868; G06F 13/385; G06F 13/4282; G06F 13/4022; G06F 12/0246; G06F 2212/452; G06F 2212/7201

(57) ABSTRACT

Embodiments of the present invention disclose a data cache and a system, a computer program product and a method for data caching, wherein a data cache includes: at least one memory bank adapted for enabling high-speed data access; and at least one converter configured to receive a first instruction for a data access operation, and convert the first instruction to a second instruction compatible with the at least one memory bank so as to perform the data access operation, the first instruction being transmitted from a high-speed bus interface of a host device to the data cache.

### RELATED APPLICATION

This application claims priority from Chinese Patent Application Number CN201410562465.6 filed on Oct. 20, 2014 entitled “DATA CACHE DEVICE AND METHOD FOR DATA CACHING” the content and teachings of which is herein incorporated by reference in its entirety.

### FIELD OF THE INVENTION

Embodiments of the present invention relate to the technical field of data storage.

### BACKGROUND

Generally, a memory capacity of a computer system may be limited and volatile, and therefore data storage may be usually implemented by using a storage device. Conventionally, a storage device, which may have a larger capacity and be nonvolatile, may be connected to a computer system via a bus interface so as to achieve data access. Typically, although a storage device may be provided with a larger capacity, its access speed may be usually very slow.

Generally, a cache with a capacity and an access speed between capacities and access speeds of the memory of a computer and a storage device may be proposed for storing data with a frequency access stored in the storage device.

### SUMMARY OF THE INVENTION

Generally, embodiments of the present disclosure relate to a data cache and a method for data caching.

According to an embodiment of the present invention, there is provided a data cache, that includes at least one memory bank adapted for enabling high-speed data access; and at least one converter configured to receive a first instruction for a data access operation, and convert the first instruction to a second instruction compatible with the at least one memory bank so as to perform a data access operation, the first instruction may be transmitted from a high-speed bus interface of a host device to the data cache.

### BRIEF DESCRIPTION OF THE DRAWINGS

The above and other features, advantages and aspects of respective embodiments of the present disclosure will become more apparent by making references to the following detailed descriptions in conjunction with the accompanying drawings. In the accompanying drawings, the same or similar references refer to the same or similar elements, in which:

FIG. 1 shows an exemplary environment in which embodiments of the present disclosure may be implemented;

FIG. 2 shows a block diagram of a data cache according to one embodiment of the present disclosure;

FIG. 3 shows a block diagram of a system comprising a host device and a data cache according to one embodiment of the present disclosure; and

FIG. 4 shows a flow chart of a method for data caching in a data cache according to one embodiment of the present disclosure.

### DETAILED DESCRIPTION

Hereinafter, embodiments of the present disclosure will be described in detail with reference to the accompanying drawings. Although some embodiments of the present disclosure have been illustrated in the accompanying drawings, it should be understood that the present disclosure can be implemented in various forms but not construed to be limited by embodiments described here. On the contrary, providing these embodiments is to make the present disclosure understood more thoroughly and completely. It should be understood that the accompanying drawings and embodiments of the present disclosure are merely for illustration without limiting the protection scope of the present disclosure.

The term “comprising” and its variations used here indicate an open inclusion, i.e., “including, but not limited to.” The term “based on” indicates “at least partially based on.” The term “one embodiment” indicates “at least one embodiment;” the term “another embodiment” indicates “at least a further embodiment.” Relevant definitions of other terms will be provided in the description below.

According to an embodiment of the present invention, there is provided a data cache. A further embodiment may include at least one memory bank adapted for enabling high-speed data access. A further embodiment may include at least one converter that may be configured to receive a first instruction for a data access operation. A further embodiment may include converting a first instruction received to a second instruction compatible with at least one memory bank so as to perform a data access operation. A further embodiment may include a first instruction that may be transmitted from a high-speed bus interface of a host device to the data cache.

In one embodiment of the present disclosure, there is provided a method for data caching. A further embodiment may include receiving a first instruction for a data access operation. A further embodiment may include a first instruction being transmitted from a high-speed bus interface of a host device to a data cache. A further embodiment may include converting a first instruction into a second instruction compatible with at least one memory bank so as to perform a data access operation. A further embodiment may include at least one memory bank being adapted for enabling high-speed data access.

One embodiment may include a computer program product. A further embodiment may include a computer program product that may be tangibly stored on a non-transient computer readable storage medium and may include a machine executable instruction. A further embodiment may include, instruction, when being executed, may cause the machine to perform steps of the method disclosed above.

It may be appreciated through the following description that according to the embodiments of the present disclosure, a high-speed data cache may be provided. Furthermore, according to some embodiments of the present disclosure, a large-capacity data cache may be provided simultaneously.

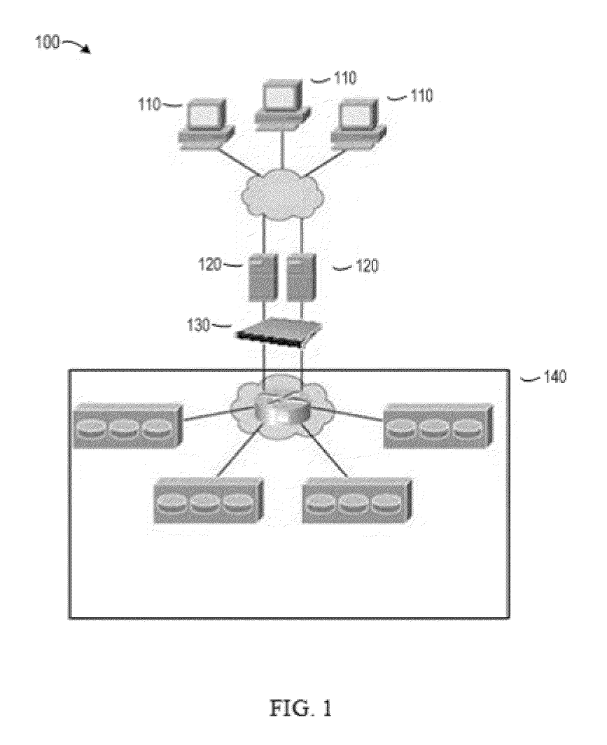

Reference is first made to FIG. 1, which shows an exemplary environment 100 in which embodiments of the present disclosure may be implemented. As shown, the environment 100 generally comprises one or more clients 110 and one or more host devices 120. Client 110 and server 120 may communicate with each other via a network connection. Server 120 may be any appropriate device that is able to communicate with client 110 and provide services to client 110. A network connection is any appropriate connection or link that enables bidirectional data communication between client 110 and server 120. Environment 100 may also comprise one or more storage devices 140. Host device 120 may perform data read/write operations on storage device 140. Storage device 140 may be removable or non-removable non-volatile computer storage medium.

Environment 100 further includes a cache 130. The cache 130 may be provided with a capacity and access speed between the capacities and access speeds of the memory of the host device 130 and a storage device, which may be used for caching data with a higher access frequency stored in the storage device.

In one embodiment, client 110 may be any appropriate devices. In an example embodiment, examples of the client may include, but may not be limited to, one or more of the following: a personal computer (PC), a laptop computer, a tablet computer, a mobile phone, a personal digital assistant (PDA), and the like.

In an example embodiment, examples of the server may include, but may not be limited to, a host, a blade server, a PC, a router, a switch, a laptop computer, a tablet computer, and the like. In some embodiments, server 120 may also be implemented as a mobile device.

In one embodiment, the network connection may be a wired or wireless connection or a combination thereof. In an example embodiment, a network connection may include, but may not be limited to, one or more of the following: a computer network such as a local area network (LAN), wide area network (WAN), and Internet, a telecommunications network such as 2G, 3G or 4G, and a near-field communication network, and the like.

In one embodiment, the host device 120 may be implemented by a general computing device. In an example embodiment, the host device may include, but may be not limited to, one or more processors or processing units, a memory, and a bus connecting different system components (including a processor or processing unit and a memory).

In one embodiment, a bus indicates one or more of a plurality of types of bus structures, including data bus, address bus, control bus, extension bus, local bus, and the like. In an example embodiment, an architecture may include, but may not be limited to, an industrial standard architecture (ISA) bus, a micro-channel architecture (MAC) bus, an enhanced-ISA bus, a video electronics standards association (VESA) local area bus, a peripheral component interconnect (PCI) bus, and a peripheral component interconnect express (PCIe) bus.

In an example embodiment, a storage device may include a read-only memory (ROM), an optical disk (CD) ROM, a magnetic disk and a magnetic tape, and a disk array, and the like. In a further embodiment, a disk array may for example include a network attached storage (NAS) device, a storage area networking (SAN) device and/or a direct-access storage (DAS) device.

It should be understood that the numbers of clients 110, host devices 120, and storage devices 140 shown in FIG. 1 are only for the purpose of illustration without suggesting any limitation.

In one embodiment, a type of cache is a PCIe-based Flash cache. In a further embodiment, use of the Flash technology ensures that the capacity of such cache may be relatively large. In a further embodiment, however, access speed for a Flash technology-based cache may be usually very low. In an example embodiment, a read/write delay may be relatively long, that is, the time lag from initiation of a read/write request to completion of a read/write operation may be relatively long. In an alternate embodiment, input/output operations per second (IOPS) may be relatively low, that is, the number of requests that may be processed in unit time may be relatively small.

In an additional embodiment, a cache may always be made into a form of single card according to the PCIe standard, which may result in certain limitation in the aspects of size and capacity. In a further embodiment, a card-insertion mode may not enable hot plug. In a further embodiment, when it may be needed to maintain a cache, such as replace, add, and/or remove, it may be needed to power off a host device, which may result in unnecessary service interruption.

In one embodiment, another type of cache may be a Flash disk array based on serial attached small computer system interface (SAS). In a further embodiment, this disk array may overcome a size and capacity limitation of the previous type of cache caused by a single-card form. In a further embodiment, however, due to introduction of SAS technology, an extra protocol conversion between a SAS and a PCIe may be desired, which may cause a longer read/write delay and a lower IOPS of this cache relative to the previous type of cache.

In one embodiment, a further type of cache may be based on an ultraDIMM technology using Flash instead of dual in-line memory module (DIMM). In an example embodiment, a Flash may be made into a memory bar, e.g., DIMM bar, and may be directly inserted into the DIMM slot of a host server. In a further embodiment, use of a Flash may likewise increase a storage capacity. In a further embodiment, a cache may use a faster double data rate (DDR) technology to access, such that the access speed may be higher.

In one embodiment, a form of memory bar may still have limitations in size and capacity, and a Flash bar may occupy a limited space in a host device for placing a memory bar, and may cause a decrease of a capacity of the memory of a host computer. In a further embodiment, a form of memory bar likewise may not be able to enable hot plug. In a further embodiment, a Flash may still have a problem that the access speed may not be sufficiently high enough.

In one embodiment, implementation of a cache may be done by using a non-volatile DIMM (NVDIMM) bar instead of the DIMM bar, and meanwhile adding a NAND Flash and a backup power supply. In a further embodiment, when a NVDIMM is power off, data stored therein may be all migrated to the NAND Flash by using the backup power supply. In a further embodiment, a data access rate and a reliability of this implementation may be both high. In a further embodiment, however, this technology may also have similar problems like an ultraDIMM technology that may be due to the form of memory bar. In a further embodiment, because the capacity of NVDIMM may be very limited, the capacity of such a cache may be very low.

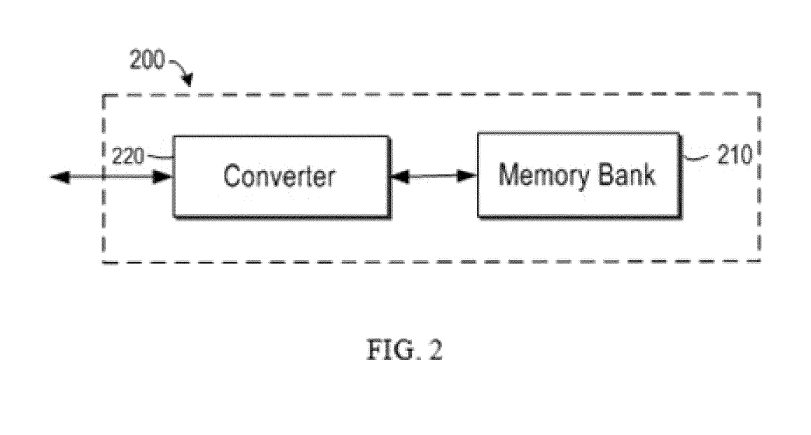

FIG. 2 shows a block diagram of a data cache 200 according to one embodiment of the present disclosure.

As shown, data cache 200 comprises at least one memory bank 210. Memory bank 210 is adapted for enabling high-speed data access. In one embodiment, one memory bank 210 may be a set of NVDIMMs.

In order to save costs, in another embodiment, memory bank 210 may further comprise a set of DIMMs, wherein data may be stored in the NVDIMMs and DIMM, respectively. In this embodiment, data may be stored in a NVDIMM and DIMM, respectively. In an example embodiment, relatively more important data may be stored in a NVDIMM, while not-so-important data may be stored in a DIMM. In an alternate embodiment, data may be stored respectively in a NVDIMM and DIMM according to discriminations of read and write operations. In an example embodiment, data subject to a write operation may be stored in a NVDIMM, while data subject to a read operation may be stored in a DIMM.

In some embodiments, a NVDIMM or DIMM may be accessed using DDR technology, and therefore data access speed of a memory bank may be very high. In an example embodiment, a read/write delay may be lower and an IOPS is higher. In one embodiment, NVDIMM and DIMM may be only examples of a memory.

In one embodiment, a number of memory banks and a number of memories in a memory bank may be selected dependent on capacity demands. In an example embodiment, when a higher storage capacity may be needed, more memories and/or memory banks may be used. In a further embodiment, when only a lower storage capacity may be needed, the number of memories and/or memory banks may be reduced.

Referring back to FIG. 2, the data cache 200 comprises at least one converter 220. Converter 220 may be configured to receive a first instruction for a data access operation, and convert the first instruction into a second instruction compatible with the memory bank so as to perform a data access operation. In one embodiment, a memory for example may be a DDR memory, e.g., NVDIMM or DIMM. In a further embodiment, a second instruction may be an instruction for data read/write following a DDR protocol.

According to one embodiments of the present disclosure, a first instruction may be transmitted to a data cache 200 from a high-speed bus interface of a host device. In a further embodiment, a PCIe bus interface may enable a very high data transmission rate. In an example embodiment, a high-speed bus interface may be a PCIe bus interface. In a further embodiment, a first instruction may be an instruction for data read/write following a PCIe protocol. In a further embodiment, converter 220 may implement conversion between two types of high-speed data transmission protocols, such as conversion between a PCIe protocol and a DDR protocol. In a further embodiment, data cache 200 may enable a high-speed data access, for example, with a lower read/write delay and a higher IOPS. In a further embodiment, a PCIe bus interface is only an example of a high-speed bus interface.

In some embodiments, it may be desirable to provide a cache with a larger capacity. In one embodiment, data cache 200 may be extended, such that it comprises a plurality of converters 220. In this embodiment, data cache 200 may also comprise a high-speed bus interface switch. In a further embodiment, a high-speed bus interface switch may be configured to couple a plurality of converters to a high-speed bus interface of a host device, so as to assign a first command to a plurality of converters.

In a further embodiment, a high-speed bus interface of a host device may be coupled to a plurality of data transmission channels via a high-speed bus interface switch, thereby increasing the cache capacity.

In order to further increase the cache capacity, in one embodiment, data cache 200 may comprise a plurality of memory banks. In this embodiment, data cache 200 may also comprise a buffer. In a further embodiment, a buffer is configured to couple a plurality of memory banks to converter 220 so as to assign a second instruction to a plurality of memory banks.

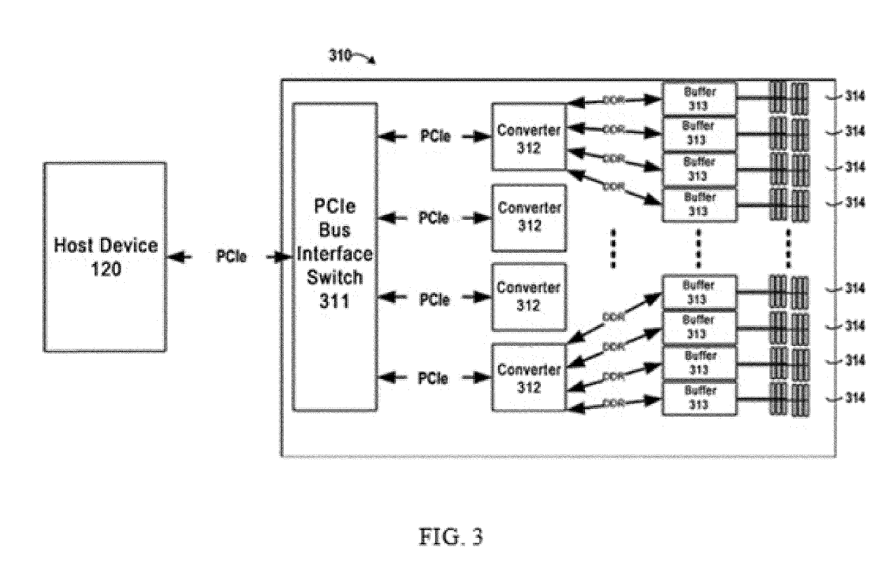

Hereinafter, a specific example of a cache with an extended capacity will be discussed with reference to FIG. 3. Specifically, FIG. 3 shows a block diagram of a system 300 according to one embodiment of the present disclosure, which includes host device 120 and data cache 310.

As shown, data cache 310 comprises PCIe bus interface switch 311. PCIe bus interface switch 311 is coupled to the high-speed bus interface (not shown) of host device 120. Cache 310 further comprises a plurality of converters 312 coupled to PCIe bus interface switch 311, each converter 312 carrying a piece of PCIe channel. A first instruction on data read/write from the high-speed bus interface of host device 120 is assigned to plurality of converters 312 via PCIe bus interface switch 311. Each converter 312 may convert a received PCIe protocol-based first instruction to a DDR-based second instruction.

As shown in FIG. 3, data cache 310 further comprises plurality of buffers 313. Each buffer 313 may couple converter 312 to plurality of memory banks 314 so as to assign a second instruction generated by converter 312 to plurality of memory banks 314. As described above, each memory bank 312 may be a set of DDR memories, e.g., DIMM or NVDIMM. In this way, data cache 310 on one hand can enable high-speed data access, and on the other hand, has a larger cache capacity.

As described above, data cache 310 in FIG. 3 is coupled to the high-speed bus interface of host device 120 through PCIe bus interface switch 311. In one embodiment, in case of no extension of a capacity of a cache with a switch, a converter in the cache may be directly coupled to a high-speed bus interface of a host device.

In one embodiment, in order to enable hot plug so as to avoid unnecessary service interruption, the high-speed bus interface may be a built-in high-speed bus interface of a host device, such as a built-in PCIe bus interface mounted on a mainboard of a host device. In a further embodiment, a data cache may be coupled to a built-in high-speed bus interface through a host bus adapter. In a further embodiment, data cache receives a first instruction for a data access operation from a built-in PCIe bus interface of a host device via a host bus adapter. In a further embodiment, a cache may also be connected to a built-in high-speed bus interface of a host device in other ways.

In another embodiment, an external high-speed bus interface of a host device may be used. In an example embodiment, a high-speed bus interface may be an external PCIe bus interface of a host device, and a cache may be coupled to the external PCIe bus interface through a data line.

In one embodiment, a converter and a high-speed bus interface switch included in data caches 200 and 310 may be implemented in various ways, including in software, hardware, firmware or any combination thereof. In an example embodiment, a converter and/or a high-speed bus interface may be implemented in software and/or firmware. In an alternate embodiment, a converter and/or a high-speed bus interface may be implemented partially or completely based on hardware. In an example embodiment, a converter and/or a high-speed bus interface may be implemented as an integrated circuit (IC) chip, an application-specific integrated circuit (ASIC), a system-on-chip (SOC), a field programmable gate array (FPGA), and the like.

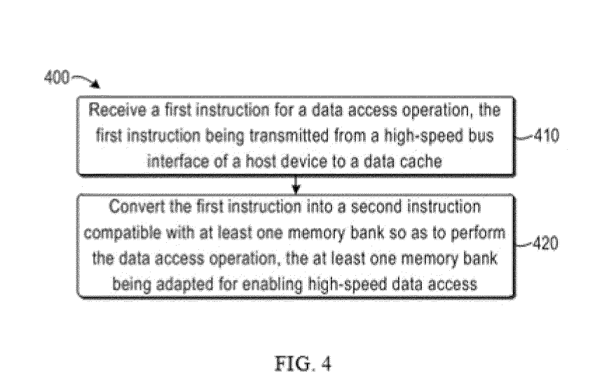

FIG. 4 shows a flow chart of a method 400 for data caching in a data cache according to one embodiment of the present disclosure.

The method 400 starts from step S410, wherein a first instruction for a data access operation is received, and the first instruction is transmitted from a high-speed bus interface of a host device to a data cache. In one embodiment, a high-speed bus interface may be a PCIe bus interface. In a further embodiment, a first instruction may be an instruction for data read/write following the PCIe protocol.

Referring to FIG. 4, in step 420, a first instruction is converted into a second instruction compatible with at least one memory bank so as to perform the data access operation. In one embodiment, a memory device set is adapted for enabling high-speed data storage. In a further embodiment, a memory bank may be, for example, a set of DDR memories, such as a set of NVDIMMs or DIMMs. In a further embodiment, a second instruction may be an instruction for data read/write following a DDR protocol.

In one embodiment, the receiving action in step 410 and the converting action in step 420 may be performed by at least one converter in a data cache. In a further embodiment, through the converting, a conversion between two types of high-speed data transmission protocols may be implemented, such as a conversion between a PCIe protocol and a DDR protocol, thereby enabling high-speed data access.

In order to increase cache capacity, in one embodiment, a data cache may comprise a plurality of converters. In this embodiment, in step 410, a first instruction may be received through a high-speed bus interface switch, and the first instruction may be assigned to the plurality of converters from the high-speed bus interface switch for instruction conversion. In a further embodiment, a plurality of data transmission channels may be provided through the plurality of converters, thereby increasing cache capacity.

In order to further increase cache capacity, in one embodiment, a data cache may comprise a plurality of memory banks. In this embodiment, method 400 may further include transmitting a second instruction to a buffer coupled to the plurality of memory banks, and may also include assigning a second instruction from a buffer to a plurality of memory banks.

It should be understood that the steps in method 400 may be performed by data caches described with reference to FIGS. 2 and 3, respectively. Therefore, the features described above with reference to FIGS. 2 and 3 are likewise applicable to method 400 and achieve the same effect. The details will be omitted here.

In one embodiment, the present disclosure may be a device, a method, and/or a computer program product. In a further embodiment, a computer program product may be tangibly stored on a non-transient computer readable medium and includes a machine executable instruction causing, when being executed, the machine to implement various aspects of the present disclosure, such as perform the steps of the above method 400.

In one embodiment, a computer readable storage medium may be a tangible device that may store instructions used by an instruction execution device. In a further embodiment, a computer readable storage medium may include, but may be not limited to, for example, an electronic storage device, a magnetic storage device, an optical storage device, an electromagnetic storage device, a semiconductor storage device, or any suitable combination thereof. In a further embodiment, a non-exhaustive list of more specific examples of the computer readable storage medium may include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination thereof. In a further embodiment, a computer readable storage medium, as used herein, may not be construed as being transitory signals per se, such as radio waves or other electromagnetic waves freely propagating, electromagnetic waves propagating through a waveguide or other transmission media (e.g., light pulses passing through a fiber-optic cable), or electrical signals transmitted through a wire.

In one embodiment, a machine executable instruction described here may be downloaded to respective computing/processing devices from a computer readable storage medium, or downloaded to an external computer or external storage device through a network, such as the Internet, a local area network, a wide area network, and/or a wireless network. In a further embodiment, a network may comprise a copper transmission cable, an optical fiber transmission, a router, a firewall, a switch, a gateway computer and/or an edge server. In a further embodiment, a network adapter card or a network interface in each computing/processing device may receive a computer readable program instruction from the network and may forward a computer readable program instruction for storage in a computer readable storage medium in individual computing/processing devices.

In one embodiment, computer program instructions for implementing operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, and the like, and conventional procedural programming languages, such as the “C” programming language or similar programming languages. In a further embodiment, a computer readable program instruction may be executed completely on the user's computer, partly on the user's computer, as a stand-alone software package, partly on the user's computer and partly on a remote computer, or completely on the remote computer or server. In a further embodiment, in a case involving a remote computer, the remote computer may be connected to a user's computer through any type of network, including a local area network (LAN) or a wide area network (WAN), or may be connected to an external computer (for example, through the Internet using an Internet Service Provider). In some embodiments, electronic circuitry, such as programmable logic circuitry, field-programmable gate arrays (FPGA), or programmable logic arrays (PLA), may be customized by utilizing state information of the computer readable program instructions, which may execute a computer readable program instructions in order to perform aspects of the present invention.

Aspects of the present disclosure are described herein with reference to flowcharts and/or block diagrams of the device, method, and computer program product according to embodiments of the present disclosure. It will be understood that each block of the flowcharts and/or block diagrams, and combinations of blocks in the flowcharts and/or block diagrams may be implemented by computer readable program instructions.

Various embodiments of the present disclosure have been described above for the purpose of illustration. However, the present disclosure is not intended to limit these embodiments as disclosed. Without departing from the essence of the present disclosure, all modifications and variations fall into the protection scope of the present disclosure defined by the claims.

What is claimed is:

1. A data cache, comprising:
at least one memory bank adapted for enabling high-speed data access; and
at least one converter configured to receive a first instruction for a data access operation, and convert the first instruction to a second instruction compatible with the at least one memory bank so as to perform the data access operation, the first instruction being transmitted from a high-speed bus interface of a host device to the data cache.

2. The data cache according to claim 1, wherein the at least one converter comprises a plurality of converters, and the data cache further comprising:
a high-speed bus interface switch configured to couple the plurality of converters to the high-speed bus interface of the host device and to assign the first instruction to the plurality of converters.

3. The data cache according to claim 1, wherein the at least one memory bank comprises a plurality of memory banks, and the data cache further comprising:
a buffer configured to couple the plurality of memory banks to the at least one converter and to assign the second instruction to the plurality of memory banks.

4. The data cache according to claim 3, wherein the first instruction is transmitted to the data cache from the high-speed bus interface of the host device through a host bus adapter.

5. The data cache according to claim 3, wherein the high-speed bus interface comprises a peripheral component interconnection express (PCIe) bus interface.

6. The data cache according to claim 3, wherein the memory bank comprises at least one double data rate (DDR) memory.

7. The data cache according to claim 6, wherein the DDR memory comprises a non-volatile dual in-line memory module (NVDIMM).

8. A method for data caching, comprising:
receiving a first instruction for a data access operation, the first instruction being transmitted from a high-speed bus interface of a host device to a data cache; and
converting the first instruction into a second instruction compatible with at least one memory bank so as to perform the data access operation, the at least one memory bank being adapted for enabling high-speed data access.

9. The method according to claim 8, wherein receiving the first instruction for the data access operation comprises:
receiving the first instruction from the high-speed bus interface of the host device via a high-speed bus interface switch; and
assigning the first instruction to a plurality of converters from the high-speed bus interface switch for the converting.

10. The method according to claim 8, wherein the at least one memory bank comprises a plurality of memory banks, the method further comprising:
transmitting the second instruction to a buffer coupled to the plurality of memory banks; and
assigning the second instruction from the buffer to the plurality of memory banks.

11. The method according to claim 10, wherein the first instruction is transmitted to the data cache from the high-speed bus interface of the host device through a host bus adapter.

12. The method according to claim 10, wherein the high-speed bus interface comprises a peripheral component interface express (PCIe) bus interface.

13. The method according to claim 10, wherein the memory bank comprises at least one double data rate (DDR) memory.

14. The method according to claim 13, wherein the DDR memory comprises a non-volatile dual in-line memory module (NVDIMM).

15. A computer program product for data caching, computer program product comprising:
a non-transient computer readable medium encoded with computer executable program code, the code configured to enable the execution of:
receiving a first instruction for a data access operation, the first instruction being transmitted from a high-speed bus interface of a host device to a data cache; and
converting the first instruction into a second instruction compatible with at least one memory bank so as to perform the data access operation, the at least one memory bank being adapted for enabling high-speed data access.

16. The computer program product according to claim 15, wherein receiving the first instruction for the data access operation comprises:
receiving the first instruction from the high-speed bus interface of the host device via a high-speed bus interface switch; and
assigning the first instruction to a plurality of converters from the high-speed bus interface switch for the converting.

17. The computer program product according to claim 15, wherein the at least one memory bank comprises a plurality of memory banks, the method further comprising:
transmitting the second instruction to a buffer coupled to the plurality of memory banks; and
assigning the second instruction from the buffer to the plurality of memory banks.

18. The computer program product according to claim 17, wherein the first instruction is transmitted to the data cache from the high-speed bus interface of the host device through a host bus adapter.

19. The computer program product according to claim 15, wherein the high-speed bus interface comprises a peripheral component interface express (PCIe) bus interface.

20. The computer program product according to claim 15, wherein the memory bank comprises at least one double data rate (DDR) memory, and wherein the DDR memory comprises a non-volatile dual in-line memory module (NVDIMM).
